(19) United States
(12) Patent Application Publication
(10) Pub. No.: US 2016/0137901 A1
(43) Pub. Date: May 19, 2016

(54) CLAY INHIBITORS FOR DRILLING, FRACTURING, AND OTHER PROCEDURES

(71) Applicant: MEADWESTVACO CORPORATION, Richmond, VA (US)

(72) Inventors: Andrew T. Bickford, Goose Creek, SC (US); Reinaldo C. Navarrete, Houston, TX (US); David J. Northrup, II, Mount Pleasant, SC (US)

(21) Appl. No.: 14/898,043

(22) PCT Filed: May 20, 2014
(86) PCT No.: PCT/US2014/038727

§ 371 Date: Dec. 11, 2015

Related U.S. Application Data
(60) Provisional application No. 61/834,108, filed on Jun. 12, 2013.

(51) Int. Cl. C09K 8/06; E21B 43/26; C09K 8/68

(52) U.S. Cl. CPC C09K 8/06; C09K 8/68; E21B 43/26; C09K 2208/12

(57) ABSTRACT

Reaction products produced by reacting a maleated tall oil fatty acid and/or a maleated soy oil fatty acid with an ethylene amine material are used as clay inhibitors in drilling fluids and in hydraulic fracturing fluids for drilling wells and for fracturing subterranean formations, and are also used as clay inhibitors in other treatment fluids for treating wells or subterranean formations.

### CROSS-REFERENCE TO RELATED APPLICATION

This application claims the benefit of U.S. Provisional Application No. 61/834108, filed Jun. 12, 2013, and incorporates the same herein by reference in its entirety.

### FIELD OF THE INVENTION

The present invention relates to compositions for inhibiting clay swelling and to the use of such inhibitor compositions in drilling, fracturing, and other procedures.

### BACKGROUND OF THE INVENTION

A need exists for improved chemical formulations that are effective for inhibiting clay swelling, particularly when conducting drilling, fracturing, or other operations in shale formations. Shale formations are rich in clay content. They are horizontally drilled and then hydraulically fractured in multiple stages. Clay is by nature hydrophilic and in the presence of water it tends to absorb water and swell. In some cases it may even disintegrate. During the drilling process, this may cause the hole to cave or cause the drilling cuttings to disintegrate into fines, which cannot be removed easily on the surface from the drilling fluid. During hydraulic fracturing, clay swelling may negatively affect production due to formation embedment in the proppant pack.

Water-based drilling fluids (muds) typically comprise a mixture of water and clay (e.g., bentonite) and also commonly include clay inhibitors and/or other chemicals. The drilling fluid is circulated through the well bore during drilling in order to lubricate and cool the drill bit, flush the cuttings out of the well, and strengthen the sides of the hole to prevent cave-ins. Typically, the drilling fluid is delivered downwardly into the well through the drill string and then returns upwardly through the annulus formed between the drill string and wall of the borehole.

Hydraulic fracturing fluids typically comprise water and sand, or other proppant materials, and also commonly include various types of chemical additives. Examples of such additives include: gelling agents which assist in suspending the proppant material; crosslinkers which help to maintain fluid viscosity at increased temperatures; gel breakers which operate to break the gel suspension after the fracture is formed and the proppant is in place; friction reducers; clay inhibitors; corrosion inhibitors; scale inhibitors; acids; surfactants; antimicrobial agents; and others. The hydraulic fracturing fluid is pumped into the subterranean formation under sufficient pressure to create, expand, and/or extend fractures in the formation and to thus provide enhanced recovery of the formation fluid.

### SUMMARY OF THE INVENTION

The present invention provides an inhibitor composition which is well suited for use in drilling and fracturing fluids and procedures of the type described above. The composition is surprisingly and unexpectedly effective for inhibiting clay swelling and has a desirably low toxicity level. The inventive inhibitor and the inventive drilling and fracturing compositions produced therefrom are therefore particularly effective for use in drilling and fracturing shale formations.

The inhibitor composition is also well suited for use in other fluids and operations for treating wells or subterranean formations. Examples include, but are not limited to, completion fluids, water, polymer, surfactant, surfactant/polymer flood fluids, conformance control fluids, workover or other well treatment fluids.

In one aspect of the present invention, there is provided a method of drilling a well wherein a drilling fluid is circulated through a well bore as the well is being drilled. In accordance with the improvement provided by the present invention, the drilling fluid includes an amount of an inhibitor composition effective to at least reduce clay swelling occurring in the well as the drilling fluid is circulated through the well bore, wherein the inhibitor composition is a reaction product which has been produced by reacting a maleated fatty acid material with an ethylene amine material, wherein the maleated fatty acid material is maleated tall oil fatty acid, maleated soy oil fatty acid, or a combination thereof.

In another aspect, there is provided a method of fracturing a subterranean formation comprising injecting a fracturing fluid into the subterranean formation. In accordance with the improvement provided by the present invention, the fracturing fluid includes an amount of an inhibitor composition effective to at least reduce clay swelling occurring in the subterranean formation when the fracturing fluid is injected, wherein the inhibitor composition is a reaction product which has been produced by reacting a maleated fatty acid material with an ethylene amine material, wherein the maleated fatty acid material is maleated tall oil fatty acid, maleated soy oil fatty acid, or a combination thereof.

In another aspect, there is provided a method of treating a well or a subterranean formation comprising injecting a treatment fluid into the well or the subterranean formation. In accordance with the improvement provided by the present invention, the treatment fluid includes an amount of an inhibitor composition effective to at least reduce clay swelling occurring during injection, wherein the inhibitor composition is a reaction product which has been produced by reacting a maleated fatty acid material with an ethylene amine material, wherein the maleated fatty acid material is maleated tall oil fatty acid, maleated soy oil fatty acid, or a combination thereof.

Further aspects, features, and advantages of the present invention will be apparent to those of ordinary skill in the art upon examining the accompanying drawing and upon reading the following Detailed Description of the Preferred Embodiments.

### BRIEF DESCRIPTION OF THE DRAWING

FIG. 1 is a graph showing viscosity vs. shear test results for inhibitor compositions of the present invention as compared to prior art inhibitor compositions.

### DETAILED DESCRIPTION OF THE PREFERRED EMBODIMENTS

The present invention provides improved compositions and methods for drilling wells, fracturing subterranean formations, and other treatments. The inventive drilling and fracturing compositions and methods are particularly effective for use in shale formations but can also be used in generally any other type of formation.

In the inventive drilling method, a drilling fluid (preferably a water-based drilling fluid) including an inhibitor composition provided by the present invention is circulated through the well bore as the well is being drilled.

In the inventive fracturing method, a fracturing fluid including the inhibitor composition provided by the present invention is injected into a subterranean formation, preferably under sufficient pressure to create, expand, and/or extend fractures in the formation and to thereby provide enhanced recovery of the formation fluid.

Similarly, in other treatment methods provided by the present invention for treating wells or subterranean formations, a treatment fluid including a sufficient amount of the inhibitor composition provided by the present invention to at least reduce clay swelling is injected into the well or formation. Examples of such treatment fluids include, but are not limited to, completion fluids, water, polymer, surfactant, surfactant/polymer flood fluids, conformance control fluids, workover or other well treatment fluids.

The inhibitor composition provided and used in accordance with the present invention preferably comprises a reaction product which has been produced by reacting a maleated fatty acid material with an ethylene amine material. The maleated fatty acid material is preferably maleated tall oil fatty acid, maleated soy oil fatty acid, or a combination thereof The maleated fatty acid material is most preferably maleated tall oil fatty acid.

The maleated fatty acid material used for producing the inhibitor employed in the present invention will preferably be produced by the reaction of tall oil fatty acid, soy oil fatty acid, or a combination thereof with maleic anhydride. The tall oil fatty acid and/or soy oil fatty acid used for producing the inhibitor will preferably have a linoleic acid content of at least 30% by weight of the total weight of the tall oil and/or soy oil fatty acid material. The linoleic acid content of the tall oil and/or soy oil fatty acid material will more preferably be in the range of from about 35% to about 70% by weight of the tall oil and/or soy oil fatty acid material.

The linoleic acid present in the tall oil and/or soy oil fatty acid material will preferably be a conjugated linoleic acid, but can also be a non-conjugated acid if an iodine catalyst is used when reacting the fatty acid material with the maleic anhydride. Non-conjugated linoleic acid is converted to the conjugated form in the presence of the iodine. The conjugated linoleic acid reacts with the maleic anhydride to form an anhydride ring structure on the fatty acid. This anhydride subsequently reacts with the ethylene amine material in the next stage of the reaction process to form the final inhibitor product. Therefore, a higher linoleic acid content in the starting tall oil and/or soy oil fatty acid reactant material ensures a good reaction yield for the final inhibitor product.

By way of example, but not by way of limitation, one maleated tall oil fatty acid material (referred to in the Example below as maleated TOFA-1) which is preferred for use in the present invention is preferably produced by forming a reaction mixture comprising tall oil fatty acid, molten maleic anhydride, iodine, and glacial acetic acid and reacting the mixture at a temperature of from about 430° F. to about 480° F. and an elevated pressure (most preferably about 80 psig) for about one to three hours. The concentrations of the reaction system components, based upon the total weight of the reaction system mixture, will preferably be as follows:
a. Tall oil fatty acid reactant 80-90% by weight
b. Maleic anhydride reactant 10-20% by weight
c. Iodine about 0.1% by weight
d. Glacial acetic acid about 0.10-0.12% by weight

By way of further example, but not by way of limitation, another maleated tall oil fatty acid material (referred to in the Example below as maleated TOFA-2) which is preferred for use in the present invention is preferably produced by forming a reaction mixture comprising tall oil fatty acid, molten maleic anhydride, and glacial acetic acid and reacting the mixture at a temperature of from about 400° F. to about 460° F. and an elevated pressure (most preferably about 80 psig) for about two to five hours. The concentrations of the reaction system components, based upon the total weight of the reaction system mixture, will preferably be as follows:
a. Tall oil fatty acid reactant 70-80% by weight
b. Maleic anhydride reactant 18-28% by weight
c. Glacial acetic acid about 0.10-0.12% by weight

In the next stage of the reaction process for producing the inhibitor product, the maleated fatty acid material is reacted with an ethylene amine material. Examples of ethylene amine materials suitable for reaction with the maleated fatty acid material to produce the inhibitor product include, but are not limited to: diethylenetriamine (DETA); triethylenetetramine (TETA); tetraethylenepentamine (TEPA); heptaethyleneoctamine (HEOA); hexaethyleneheptamine (HEHA); Amine HST; aminoethylpiperazine (AEP); dimethylaminopropylamine (DMAPA); other ethylene amines having an average of from 6 to 10 nitrogen atoms; and combinations thereof.

By way of example, but not by way of limitation, the second stage of the reaction process for producing the inhibitor product can be performed by the following steps. All percentages stated in this procedure are percentages by weight based upon the total weight of all of the components used in the reaction charge.
a. Combining, with agitation, from about 40% to about 60% water with from about 10% to about 30% of the ethylene amine reactant material;
b. Adding, with agitation, from about 20% to about 40% of the maleated fatty acid reactant material to the mixture to form the total reaction charge; and
c. Reacting the reaction charge at from about 140° F. to about 200° F., typically about 3 hours, to produce the inhibitor product.

The presence of water in the reaction charge operates to prevent the formation of amides in the reaction product and also reduces the viscosity of the final inhibitor product. In this regard, the inhibitor composition which is added to a drilling fluid, a fracturing fluid, or other treatment fluid in accordance with the present invention will preferably be in the form of an aqueous dilution comprising about 50% by weight of the active inhibitor and about 50% by weight water.

In the inventive drilling method, the inhibitor composition provided by the present invention will preferably be used in the drilling fluid (preferably a water-based drilling fluid) in an amount effective to at least reduce clay swelling occurring in the well as the drilling fluid is circulated through the well bore. The inhibitor composition will more preferably be used in an amount in the range of from about 0.5% to about 5% by weight and will most preferably be used in amount of from about 2% to about 4% by weight, based upon the total weight of the drilling fluid.

In the inventive fracturing method, the inhibitor composition provided by the present invention will preferably be used in the hydraulic fracturing fluid in an amount effective to at least reduce clay swelling occurring in the subterranean formation when the fracturing fluid is injected. The inhibitor composition will more preferably be used in an amount in the range of from about 0.05% to about 2% by weight and will most preferably be used in an amount in the range of from about 0.2% to about 0.7% by weight, based upon the total weight of the hydraulic fracturing fluid.

The following example is meant to illustrate, but in no way limit, the claimed invention.

### Example 1

A maleated TOFA-1 composition was prepared as described above using 85.3 wt % tall oil fatty acid, 14.49 wt % maleic anhydride, 0.1 wt % iodine, and 0.11 wt % glacial acetic acid in the reaction mixture and holding the reaction mixture at a reaction temperature of about 465° F. for about 75 minutes.

A maleated TOFA-2 composition was prepared as described above using 76.21 wt % tall oil fatty acid, 23.68 wt % maleic anhydride, and 0.11 wt % glacial acetic acid in the reaction mixture and holding the reaction mixture at a reaction temperature of about 430° F. for four hours.

A maleated tall oil fatty acid reactant material was prepared by combining two parts by weight of the TOFA-1 composition with one part by weight of the TOFA-2 composition.

An inhibitor “Product 1” was prepared by (a) slowly adding, with agitation, 50 wt % water to an ethylene amine reactant composition comprising 18.38 wt % diethylenetriamine (DETA), 0.18 wt % triethylenetetramine (TETA), and 0.18 wt % tetraethylenepentamine (TEPA), (b) slowly adding 31.26 wt % of the maleated tall oil fatty acid reactant material to this mixture with agitation, and (c) holding the resulting reaction mixture at a reaction temperature of 195-200° F. for 3 hours.

An inhibitor “Product 2” was prepared by (a) slowly adding, with agitation, an ethylene amine reactant composition comprising 0.18 wt % (DETA), 0.18 wt % (TETA), and 19.92 wt % tetraethylenepentamine (TEPA) to 50 wt % water, (b) slowly adding 29.72 wt % of the maleated tall oil fatty acid reactant material to this mixture with agitation, and (c) holding the resulting reaction mixture at a reaction temperature of 195-200° F. for 3 hours.

Additional inhibitor composition were also prepared in accordance with present invention using the reactants, reactant amounts, and reaction temperatures shown in the following table:

| | | | Maleated | | | | Maleated | |
|---|---|---|---|---|---|---|---|---|
| | | Amine | TOFA Mix⁺⁺ | Water | Amine | Temperature 1* | TOFA Mix⁺⁺ | Temperature 2⁺ |
| Inhibitor | Amine | mol | mol | gr | gr | deg. F. | gr | deg F. |
| 8845-20A | DETA | 1.05 | 1 | 50.02 | 11.13 | 92.6 | 38.81 | 150.6 |
| 8845-20B | DETA | 1.20 | 1 | 50.01 | 12.34 | 106.5 | 37.69 | 162.6 |
| 8845-20C | DETA | 1.35 | 1 | 50.04 | 13.48 | 99.9 | 37.03 | 148.0 |
| 8845-20D | TETA | 1.05 | 1 | 50.04 | 14.48 | 102.9 | 35.43 | 149.7 |
| 8845-20E | TETA | 1.20 | 1 | 50.03 | 15.89 | 105.2 | 34.13 | 152.1 |
| 8845-20F | TETA | 1.35 | 1 | 50.05 | 17.15 | 110.2 | 32.82 | 146.0 |
| 8845-20G | TEPA | 1.05 | 1 | 50.01 | 17.36 | 104.6 | 32.52 | 144.9 |
| 8845-20H | TEPA | 1.20 | 1 | 50.01 | 18.90 | 110.3 | 31.11 | 148.7 |
| 8845-20I | TEPA | 1.35 | 1 | 50.04 | 20.28 | 113.1 | 29.91 | 147.6 |
| 8845-20J | EA-300** | 1.05 | 1 | 50.03 | 23.54 | 115.3 | 26.34 | 141.0 |
| 8845-20K | EA-300 | 1.20 | 1 | 50.03 | 25.20 | 118.0 | 24.94 | 144.8 |
| 8845-20L | EA-300 | 1.35 | 1 | 50.03 | 26.67 | 119.8 | 23.25 | 144.0 |

⁺⁺Maleated TOFA Mix is a mixture of two parts by weight of TOFA-1 and one part by weight of TOFA-2
*Temperature 1 is the temperature from the exotherm ater adding the Amine to the water
⁺Temperature 2 is the temperature from the exotherm after adding the Maleated TOFA Mix to the water/Amine mixture
**EA-300 is mixture of hexaethyleneheptamine and heptaethyleneoctamine with an amine value of about 7.5

For testing, each of the inhibitor reaction product materials was mixed with tap water for 10 minutes in a Hamilton Beach mixer to make a 3% wt. solution of active inhibitor in water. Next, 50 g of API Bentonite clay was added over one minute to 350 g of the 3% inhibitor solution and the mixture was stirred for 90 minutes at room temperature.

For comparison purposes, identical 3% mixtures of four well-known high performance inhibitors currently used in the art were prepared using the same procedure. The prior art inhibitors were tetramethylammonium chloride (TMAC), choline chloride, Jeffamine D-230, and potassium chloride (KCl).

Rheological studies for each of the suspensions identified above were then conducted wherein, after 90 minutes of stirring, a 25 mL sample of the suspension was poured into a 50 mL beaker. If the sample foamed and did not disperse, the sample was heated (90° F.) and stirred gently on a magnetic stir plate for 2-5 minutes and the non-dispersed foam was removed with a spatula. All experiments were performed at 23.5° C. The sample was poured into the sample cup of an Anton Paar MCR-302 rheometer concentric cylinder geometry, and viscosity vs. shear rate data was recorded after a five minute temperature equilibration time. The sample was sheared from 1,000 sec⁻¹ to 0.1 sec⁻¹ over 120 minutes and the data was recorded using the Rheoplus software.

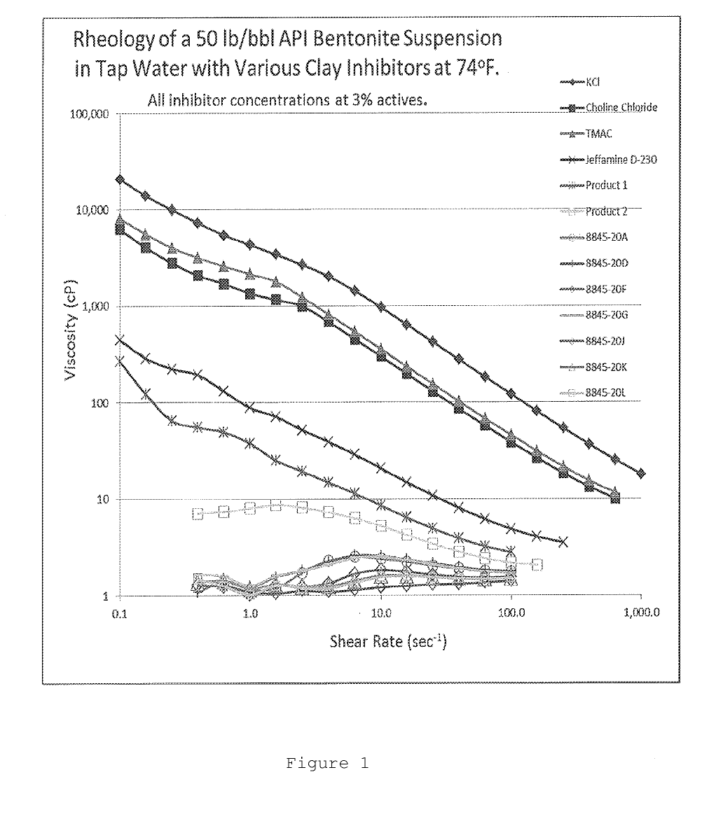

The viscosity vs. shear results for all of the inhibitors produced in accordance with the present invention versus the four comparative prior art inhibitors are provided in graphical form in FIG. 1.

The results illustrated in FIG. 1 show that not only did the inhibitors produced from maleated tall oil fatty acid in accordance with the present invention unexpectedly outperform the prior art inhibitors in the rheology tests, but the inventive inhibitors were surprisingly able to lower the viscosity of the bentonite clay suspension to within a few centipoise of water.

### Example 2

The performance of Products 1 and 2 as clay stabilizers was also investigated by retention testing. Samples of midway shale were passed through a Combustion Engineering U.S.A Standard Testing 16-mesh sieve and the small particulates that passed through the sieve were discarded, while the larger pieces were set aside for later use Inhibitor solutions were prepared in 1 L bottles by addition of inhibitor to a pre-weighed bottle, and then water was added until the final solution mass reached 875 g. The bottle was then shaken to homogenize the mixture.

Into a 250 mL pressure cell was placed 21.0 g of relatively uniform shale pieces and 234.0 g of inhibitor solution from the 1 L bottle, after which the cell was pressurized with 100 psi of nitrogen. Each inhibitor was tested in triplicate. The cells were placed into a roller oven that had been preheated to 250° F. and then rolled for 16 hours. The cells were cooled in a water bath, and the contents of the cells were collected onto the 16-mesh sieve and dried. The mass of the inhibitor-exposed shale after hot-rolling was normalized by the initial mass of shale and multiplied by 100 to give the percent of shale retained.

For the 5-day tests, the above procedure was modified so that after the initial 16-hour aging, the samples were collected and then returned to their respective pressure cells. Next, 234.0 g of water was added to each cell, and the cells were pressurized with 100 psi of nitrogen. The cells were replaced in the roller oven and then rolled for 4 additional days. After this time, solids were collected, dried, and weighed, and then percent of shale retained was calculated as per the above procedure.

The results are summarized in the table below.

| | Inhibitor | | | | | |
|---|---|---|---|---|---|---|
| | 3 wt % | | 3 wt % | | 3 wt % | 3 wt % |
| | Jeffamine | 3 wt % | Choline | 6 wt % | Product | Product |
| | D-230 | TMAC | Chloride | KCl | 1 | 2 |
| 16-h | 94.4 | 91.3 | 68.9 | 63.4 | 100.0 | 100.0 |
| Retention | | | | | | |
| (%) | | | | | | |
| 5-day | 81.5 | n/a | n/a | 9.5 | 99.0 | 99.6 |
| Retention | | | | | | |
| (%) | | | | | | |

Thus, the present invention is well adapted to carry out the objects and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within this invention as defined by the claims.

What is claimed is:

1. In a method of drilling a well wherein a drilling fluid is circulated through a well bore as said well bore is being drilled, the improvement comprising said drilling fluid including an amount of an inhibitor composition effective to at least reduce clay swelling occurring in said well as said drilling fluid is circulated through said well bore, wherein said inhibitor composition is a reaction product which has been produced by reacting a maleated fatty acid material with an ethylene amine material, wherein said maleated fatty acid material is maleated tall oil fatty acid, maleated soy oil fatty acid, or a combination thereof.

2. The method of claim 1 wherein the improvement further comprises said maleated fatty acid material being said maleated tall oil fatty acid.

3. The method of claim 1 wherein the improvement further comprises said ethylene amine material being: diethylenetriamine (DETA); triethylenetetramine (TETA); tetraethylenepentamine (TEPA); heptaethyleneoctamine (HEOA); hexaethyleneheptamine (HEHA); Amine HST; aminoethylpiperazine (AEP); dimethylaminopropylamine (DMAPA); other ethylene amines having an average of from 6 to 10 nitrogen atoms; and combinations thereof.

4. The method of claim 1 wherein the improvement further comprises said maleated fatty acid material having been produced by reacting a fatty acid material with maleic anhydride, said fatty acid material being tall oil fatty acid, soy oil fatty acid, or a combination thereof, and said fatty acid material having a linoleic acid concentration of at least 30% by weight of a total weight of said fatty acid material.

5. The method of claim 1 wherein the improvement further comprises said inhibitor composition being present in said drilling fluid in an amount of from about 0.5% to about 5% by weight based upon a total weight of said drilling fluid.

6. In a method of fracturing a subterranean formation comprising injecting a fracturing fluid into said subterranean formation, the improvement comprising said fracturing fluid including an amount of an inhibitor composition effective to at least reduce clay swelling occurring in said subterranean formation when said fracturing fluid is injected, wherein said inhibitor composition is a reaction product which has been produced by reacting a maleated fatty acid material with an ethylene amine material, wherein said maleated fatty acid material is maleated tall oil fatty acid, maleated soy oil fatty acid, or a combination thereof.

7. The method of claim 6 wherein the improvement further comprises said maleated fatty acid material being said maleated tall oil fatty acid.

8. The method of claim 6 wherein the improvement further comprises said ethylene amine material being: diethylenetriamine (DETA); triethylenetetramine (TETA); tetraethylenepentamine (TEPA); heptaethyleneoctamine (HEOA); hexaethyleneheptamine (HEHA); Amine HST; aminoethylpiperazine (AEP); dimethylaminopropylamine (DMAPA); other ethylene amines having an average of from 6 to 10 nitrogen atoms; and combinations thereof.

9. The method of claim 6 wherein the improvement further comprises said maleated fatty acid material having been produced by reacting a fatty acid material with maleic anhydride, said fatty acid material being tall oil fatty acid, soy oil fatty acid, or a combination thereof, and said fatty acid material having a linoleic acid concentration of at least 30% by weight of a total weight of said fatty acid material.

10. The method of claim 6 wherein the improvement further comprises said inhibitor composition being present in said fracturing fluid in an amount of from about 0.05% to about 2% by weight based upon a total weight of said fracturing fluid.

11. In a method of treating a well or subterranean formation wherein a treatment fluid is injected into said well or said subterranean formation, the improvement comprising said treatment fluid including an amount of an inhibitor composition effective to at least reduce clay swelling occurring in said well or said subterranean formation as said treatment fluid is injected, wherein said inhibitor composition is a reaction product which has been produced by reacting a maleated fatty acid material with an ethylene amine material, wherein said maleated fatty acid material is maleated tall oil fatty acid, maleated soy oil fatty acid, or a combination thereof.

12. The method of claim 11 wherein the improvement further comprises said maleated fatty acid material being said maleated tall oil fatty acid.

13. The method of claim 11 wherein the improvement further comprises said ethylene amine material being: diethylenetriamine (DETA); triethylenetetramine (TETA); tetraethylenepentamine (TEPA); heptaethyleneoctamine (HEOA); hexaethyleneheptamine (HEHA); Amine HST; aminoethylpiperazine (AEP); dimethylaminopropylamine (DMAPA); other ethylene amines having an average of from 6 to 10 nitrogen atoms; and combinations thereof.

14. The method of claim 11 wherein the improvement further comprises said maleated fatty acid material having been produced by reacting a fatty acid material with maleic anhydride, said fatty acid material being tall oil fatty acid, soy oil fatty acid, or a combination thereof, and said fatty acid material having a linoleic acid concentration of at least 30% by weight of a total weight of said fatty acid material.

15. The method of claim 11 wherein the improvement further comprises said inhibitor composition being present in said treatment fluid in an amount of from about 0.05% to about 5% by weight based upon a total weight of said treatment fluid.

16. The method of claim 11 wherein the improvement comprises said treatment fluid being a completion fluid, a water, polymer, surfactant, surfactant/polymer flood fluid, a conformance control fluid, workover or other well treatment fluid.
